(19) United States
(12) Patent Application Publication
(10) Pub. No.: US 2025/0029306 A1
(43) Pub. Date: Jan. 23, 2025

(54) DIGITAL MEMORIAL SYSTEM

(71) Applicant: BitHuman Inc

(72) Inventors: Steve Gu, Lafayette, CA (US); Yun Fu, Newton, MA (US)

(73) Assignee: BitHuman Inc, (omitted)

(21) Appl. No.: 18/224,059

(22) Filed: Jul. 20, 2023

(51) Int. Cl. G06T 13/40; G06V 10/77; G10L 13/027

(52) U.S. Cl. CPC G06T 13/40; G06V 10/7715; G10L 13/027; G06T 2210/16

(57) ABSTRACT

Embodiments of the present disclosure may include a digital memorial system including a memory system that stores three-dimensional (3D) or two-dimensional (2D) model data for virtual characters and voice profile model data for visual characters.

### BACKGROUND OF THE INVENTION

Embodiments of the present disclosure may include a method for providing a digital memorial system with artificial intelligence (AI) and thus provide many other novel and useful features.

### BRIEF SUMMARY

Embodiments of the present disclosure may include a digital memorial system including a memory system that stores three-dimensional (3D) or two-dimensional (2D) model data for virtual characters and voice profile model data for visual characters. In some embodiments, the 3D or 2D model data may include a human-based model. In some embodiments, the human-based model may include 3D or 2D data defining face and body of a generic human figure.

In some embodiments, voice profile model data may include voice profile data defining voice characters of the generic human figure. In some embodiments, the 2D model data may be gathered from the 2D image of human photos that may include face or the whole body. In some embodiments, the digital memorial system may be configured to generate a set of sequences of 2D images or videos with the same person in the human photos but with many different poses, views, gestures, facial expressions, and lip movements that may be configured to reflect 3D effects.

Embodiments may also include a computing system in electronic communication with the data store and configured to execute computer-readable instructions that configure the computing system to obtain input data depicting a real person. In some embodiments, the input data may include a set of video recordings of the real person, a set of pictures of the real person, a set of audio files containing voices of the real person, a file describing habits, behaviors belonging to the real person.

In some embodiments, the real person was a person who passed away. In some embodiments, a first part of the input data was submitted by a set of users of the digital memorial system. In some embodiments, the set of users were the real person's relatives, colleagues and friends. In some embodiments, a second part of the input data was submitted by the real person before the real person passed away.

Embodiments may also include providing at least a first portion of the input data to a first machine learning model configured to extract visual information regarding the real person, depicted in the set of video recordings of the real person and the set of pictures of the real person. Embodiments may also include providing at least a second portion of the input data to a second machine learning model configured to extract voice information regarding the real person depicted in at least the set of audio files containing the voices of the real person.

Embodiments may also include altering the 3D or 2D data of the human-based model based on visual information extracted by the first machine learning model to generate customized 3D or 2D model data corresponding to the real person. Embodiments may also include altering the voice profile data of the human-based model based on voice information extracted by the second machine learning model to generate customized voice profile data corresponding to the real person.

Embodiments may also include extracting, from the input media, visual information regarding a first item worn by the real person as depicted in the input media. In some embodiments, the first item may include a clothing item or an accessory. Embodiments may also include generating a virtual item corresponding to the first item worn by the real person.

In some embodiments, the virtual item includes a texture generated based on the visual information. Embodiments may also include render, within a 3D or 2D virtual environment, a series of frames for display that depict a virtual character that resembles the real person performing one or more actions. In some embodiments, a visual appearance of the virtual character as rendered may be based at least in part on the customized 3D or 2D model data and includes a depiction of the virtual character wearing the virtual item.

In some embodiments, the visual appearance of the visual character may be based at least in part on the habits, behaviors belong to the real person. In some embodiments, the visual character may be configured to speak using customized voice profile data corresponding to the real person. Embodiments may also include approve, with the consent from the set of users, the virtual character with the three-dimensional 3D or 2D model data and the voice profile data. Embodiments may also include enable the interaction between at least one of the set of users and the visual character depicting the real person who was the user's relative who passed away.

Embodiments of the present disclosure may also include a method to implement a visual memorial system, including obtaining input data from a user to the visual memorial system. In some embodiments, the visual memorial system includes a memory system that stores three-dimensional (3D) or two-dimensional (2D) model data for virtual characters and voice profile model data for visual characters.

In some embodiments, the 3D or 2D model data may include a human-based model. In some embodiments, the human-based model may include 3D or 2D data defining face and body of a generic human figure. In some embodiments, the 2D model data may be gathered from 2D image of human photos that may include face or the whole body.

In some embodiments, the digital memorial system may be configured to generate a set of sequences of 2D images or videos with same person in the human photos but with many different poses, views, gestures, facial expressions, and lip movements that may be configured to reflect 3D effects. In some embodiments, voice profile model data may include voice profile data defining voice characters of the generic human figure.

In some embodiments, a computing system may be coupled to the memory system. In some embodiments, the computing system may be in electronic communication with the data store and configured to execute computer-readable instructions that configure the computing system to. In some embodiments, the input data depicts a real person.

In some embodiments, the input data may include a set of video recordings of the real person, a set of pictures of the real person, a file describing habits, behaviors belong to the real person, and a set of audio files containing voices of the real person. In some embodiments, the real person was a person who passed away.

In some embodiments, a first part of the input data was submitted by a set of users of the digital memorial system. In some embodiments, the set of users were the real person's relatives, colleagues and friends. In some embodiments, a second part of the input data was submitted by the real person before the real person passed away.

Embodiments may also include providing at least a first portion of the input data to a first machine learning model configured to extract visual information regarding the real person, depicted in the set of video recordings of the real person and the set of pictures of the real person. Embodiments may also include providing at least a second portion of the input data to a second machine learning model configured to extract voice information regarding the real person depicted in at least the set of audio files containing the voices of the real person.

Embodiments may also include altering the 3D or 2D data of the human-based model based on visual information extracted by the first machine learning model to generate customized 3D or 2D model data corresponding to the real person. Embodiments may also include altering the voice profile data of the human-based model based on voice information extracted by the second machine learning model to generate customized voice profile data corresponding to the real person.

Embodiments may also include extracting, from the input media, visual information regarding a first item worn by the real person as depicted in the input media. In some embodiments, the first item may include a clothing item or an accessory. Embodiments may also include generating a virtual item corresponding to the first item worn by the real person.

In some embodiments, the virtual item includes a texture generated based on the visual information. Embodiments may also include rendering, within a 3D or 2D virtual environment, a series of frames for display that depict a virtual character that resembles the real person performing one or more actions. In some embodiments, a visual appearance of the virtual character as rendered may be based at least in part on the customized 3D or 2D model data and includes a depiction of the virtual character wearing the virtual item.

In some embodiments, the visual appearance of the visual character may be based at least in part on the habits, behaviors belonging to the real person. In some embodiments, the visual character may be configured to speak using customized voice profile data corresponding to the real person. Embodiments may also include approving, with the consent from the set of users, the virtual character with the 3D or 2D model data and the voice profile data. Embodiments may also include enabling the interaction between at least one of the set of users and the visual character depicting the real person who was the user's relative who passed away.

Embodiments of the present disclosure may also include a method to implement a visual memorial system, including obtaining input data from a user to the visual memorial system. In some embodiments, the visual memorial system includes a memory system that stores three-dimensional (3D) model data or two-dimensional (2D) model data for virtual characters and voice profile model data for visual characters.

In some embodiments, the 3D or 2D model data may include a human-based model. In some embodiments, the human-based model may include 3D or 2D data defining face and body of a generic human figure. In some embodiments, the 2D model data may be gathered from 2D images of human photos that may include face or the whole body.

In some embodiments, the digital memorial system may be configured to generate a set of sequences of 2D images or videos with same person in the human photos but with many different poses, views, gestures, facial expressions, and lip movements that may be configured to reflect 3D effects. In some embodiments, voice profile model data may include voice profile data defining voice characters of the generic human figure.

In some embodiments, a computing system may be coupled to the memory system. In some embodiments, the computing system may be in electronic communication with the data store and configured to execute computer-readable instructions that configure the computing system to. In some embodiments, the input data depicts a real person.

In some embodiments, the input media may include at least a video recording of the real person, a set of pictures of the real person, and a set of audio files containing voices of the real person. In some embodiments, the real person was a user's relative who passed away. In some embodiments, the input data may be submitted by the user to the digital memorial system.

Embodiments may also include providing at least a first portion of the input data to a first machine learning model configured to extract visual information regarding the real person, depicted in at least a video recording of the real person and the set of pictures of the real person. Embodiments may also include providing at least a second portion of the input data to a second machine learning model configured to extract voice information regarding the real person depicted in at least the set of audio files containing the voices of the real person.

Embodiments may also include altering the 3D or 2D data of the human-based model based on visual information extracted by the first machine learning model to generate customized 3D or 2D model data corresponding to the real person. Embodiments may also include altering the voice profile data of the human-based model based on voice information extracted by the second machine learning model to generate customized voice profile data corresponding to the real person.

Embodiments may also include extracting, from the input media, visual information regarding a first item worn by the real person as depicted in the input media. In some embodiments, the first item may include a clothing item or an accessory. Embodiments may also include generating a virtual item corresponding to the first item worn by the real person.

In some embodiments, the virtual item includes a texture generated based on the visual information. Embodiments may also include rendering, within a 3D or 2D virtual environment, a series of frames for display that depict a virtual character that resembles the real person performing one or more actions. In some embodiments, a visual appearance of the virtual character as rendered may be based at least in part on the customized 3D or 2D model data and includes a depiction of the virtual character wearing the virtual item.

In some embodiments, the visual character may be configured to speak using customized voice profile data corresponding to the real person. Embodiments may also include enabling the interaction between at least one of the set of users and the visual character depicting the real person who was the user's relative who passed away. Embodiments may also include recording the interactions between the user and the real person who was the user's relative who passed away.

Embodiments may also include getting input from the user regarding the interactions between the user and the real person who was the user's relative who passed away. Embodiments may also include improving the customized 3D or 2D model data and the customized voice profile data based on the input from the user. Embodiments may also include approving, with consent from the set of users, the virtual character with the 3D or 2D data and the voice profile data.

### BRIEF DESCRIPTION OF THE FIGURES

FIG. 1 is a block diagram illustrating a digital memorial system, according to some embodiments of the present disclosure.

FIG. 2A is a flowchart illustrating a method, according to some embodiments of the present disclosure.

FIG. 2B is a flowchart extending from FIG. 2A and further illustrating the method, according to some embodiments of the present disclosure.

FIG. 3A is a flowchart illustrating a method, according to some embodiments of the present disclosure.

FIG. 3B is a flowchart extending from FIG. 3A and further illustrating the method, according to some embodiments of the present disclosure.

FIG. 4 is an example of providing a digital memorial system with artificial intelligence (AI)

FIG. 5 is another example of providing a digital memorial system with artificial intelligence (AI).

FIG. 6 is a third example of providing a digital memorial system with artificial intelligence (AI).

### DETAILED DESCRIPTION

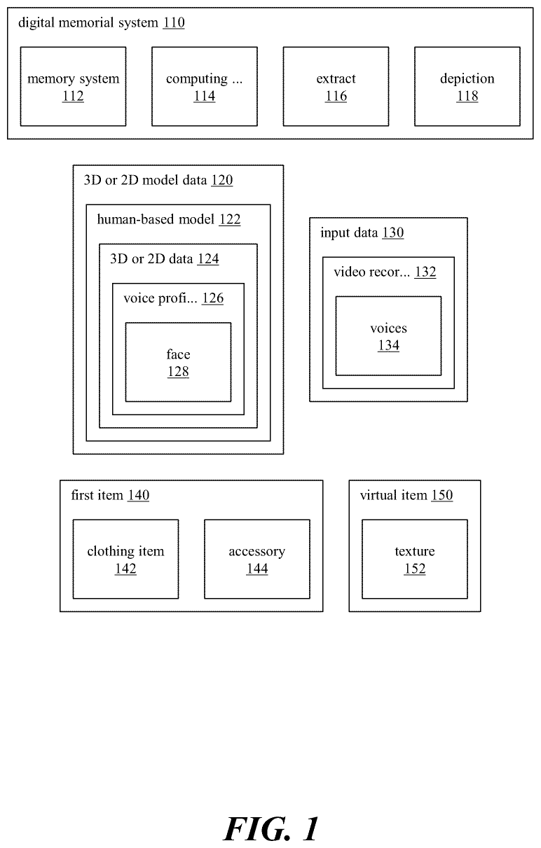

FIG. 1 is a block diagram that describes a digital memorial system 110, according to some embodiments of the present disclosure. In some embodiments, the digital memorial system 110 may include a memory system 112 that stores three-dimensional (3D) or two-dimensional (2D) model data for virtual characters and voice profile model data for visual characters, a computing system 114 in electronic communication with the data store and configured to execute computer-readable instructions that configure the computing system 114 to: and a depiction 118 of the virtual character wearing the virtual item 150. The digital memorial system 110 may also include extract 116, from the input media, visual information regarding a first item 140 worn by the real person as depicted in the input media.

In some embodiments, obtain input data 130 depicting a real person. Provide at least a first portion of the input data 130 to a first machine learning model configured to extract visual information regarding the real person, depicted in the set of video recordings 132 of the real person and the set of pictures of the real person. Provide at least a second portion of the input data 130 to a second machine learning model configured to extract voice information regarding the real person depicted in at least the set of audio files.

In some embodiments, the voices 134 of the real person. Alter the 3D or 2D data 124 of the human-based model 122 based on visual information extracted by the first machine learning model to generate customized 3D or 2D model data corresponding to the real person. Alter the voice profile data 126 of the human-based model 122 based on voice information extracted by the second machine learning model to generate customized voice profile data corresponding to the real person.

In some embodiments, generate a virtual item 150 corresponding to the first item 140 worn by the real person. Render, within a 3D or 2D virtual environment, a series of frames for display that depict a virtual character that resembles the real person performing one or more actions. A visual appearance of the virtual character as rendered may be based at least in part on the customized 3D or 2D model data. The visual appearance of the visual character may be based at least in part on the habits, behaviors belong to the real person.

In some embodiments, the visual character may be configured to speak using customized voice profile data corresponding to the real person. Approve, with the consent from the set of users, the virtual character with the three-dimensional 3D or 2D model data and the voice profile data 126. Enable the interaction between at least one of the set of users and the visual character depicting the real person who was the user's relative who passed away.

In some embodiments, the 3D or 2D model data 120 may include a human-based model 122. The human-based model 122 may include 3D or 2D data 124 defining face and body of a generic human figure. The 3D or 2D data 124 may include voice profile data 126 defining voice characters of the generic human figure. Voice profile model data. The voice profile data 126 may include face 128 or the whole body. The 2D model data 120 may be gathered from the 2D image of human photos that may.

In some embodiments, the digital memorial system 110 may be configured to generate a set of sequences of 2D images or videos with the same person in the human photos but with many different poses, views, gestures, facial expressions, and lip movements that may be configured to reflect 3D effects. The input data 130 may also include a set of video recordings 132 of the real person, a set of pictures of the real person, a set of audio files.

In some embodiments, the set of video recordings 132 may also include voices 134 of the real person, a file describing habits, behaviors belong to the real person. The real person may be was a person who passed away. A first part of the input data 130 was submitted by a set of users of the digital memorial system 110. The set of users may be were the real person's relatives, colleagues and friends. A second part of the input data 130 was submitted by the real person before the real person passed away. The first item 140 may include a clothing item 142 and an accessory 144. The virtual item 150 may include a texture 152 generated based on the visual information.

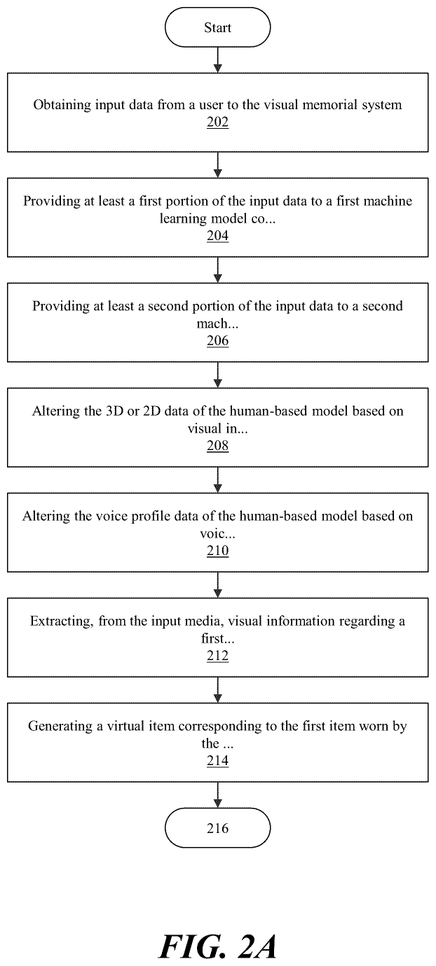

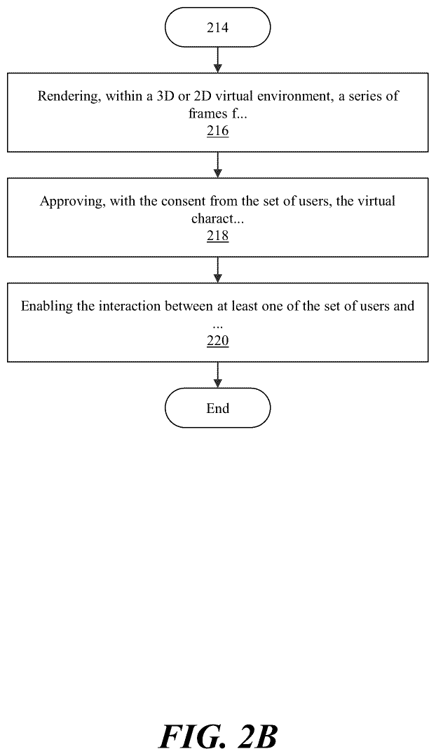

FIGS. 2A to 2B are flowcharts that describe a method, according to some embodiments of the present disclosure. In some embodiments, at 202, the method may include obtaining input data from a user to the visual memorial system. At 204, the method may include providing at least a first portion of the input data to a first machine learning model configured to extract visual information regarding the real person, depicted in the set of video recordings of the real person and the set of pictures of the real person.

In some embodiments, at 206, the method may include providing at least a second portion of the input data to a second machine learning model configured to extract voice information regarding the real person depicted in at least the set of audio files containing the voices of the real person. At 208, the method may include altering the 3D or 2D data of the human-based model based on visual information extracted by the first machine learning model to generate customized 3D or 2D model data corresponding to the real person.

In some embodiments, at 210, the method may include altering the voice profile data of the human-based model based on voice information extracted by the second machine learning model to generate customized voice profile data corresponding to the real person. At 212, the method may include extracting, from the input media, visual information regarding a first item worn by the real person as depicted in the input media.

In some embodiments, at 214, the method may include generating a virtual item corresponding to the first item worn by the real person. At 216, the method may include rendering, within a 3D or 2D virtual environment, a series of frames for display that depict a virtual character that resembles the real person performing one or more actions. At 218, the method may include approving, with the consent from the set of users, the virtual character with the 3D or 2D model data and the voice profile data.

In some embodiments, the visual memorial system may include a memory system that stores three-dimensional (3D) or two-dimensional (2D) model data for virtual characters and voice profile model data for visual characters. The 3D or 2D model data may comprise a human-based model. The human-based model comprises 3D or 2D data defining face and body of a generic human figure. The 2D model data may be gathered from 2D image of human photos that may comprise face or the whole body.

In some embodiments, the digital memorial system may be configured to generate a set of sequences of 2D images or videos with same person in the human photos but with many different poses, views, gestures, facial expressions, and lip movements that may be configured to reflect 3D effects. Voice profile model data comprises voice profile data defining voice characters of the generic human figure. A computing system may be coupled to the memory system.

In some embodiments, the computing system may be in electronic communication with the data store and configured to execute computer-readable instructions that configure the computing system to. The input data may depict a real person. The input data may comprise a set of video recordings of the real person, a set of pictures of the real person, a file describing habits, behaviors belonging to the real person, and a set of audio files containing voices of the real person.

In some embodiments, the real person was a person who passed away. A first part of the input data was submitted by a set of users of the digital memorial system. The set of users were the real person's relatives, colleagues and friends. A second part of the input data was submitted by the real person before the real person passed away. The first item may comprise a clothing item or an accessory. The virtual item may include a texture generated based on the visual information.

In some embodiments, a visual appearance of the virtual character as rendered may be based at least in part on the customized 3D or 2D model data and includes a depiction of the virtual character wearing the virtual item. The visual appearance of the visual character may be based at least in part on the habits, behaviors belong to the real person. The visual character may be configured to speak using customized voice profile data corresponding to the real person. At 220, the approving may include enabling the interaction between at least one of the set of users and the visual character depicting the real person who was the user's relative who passed away.

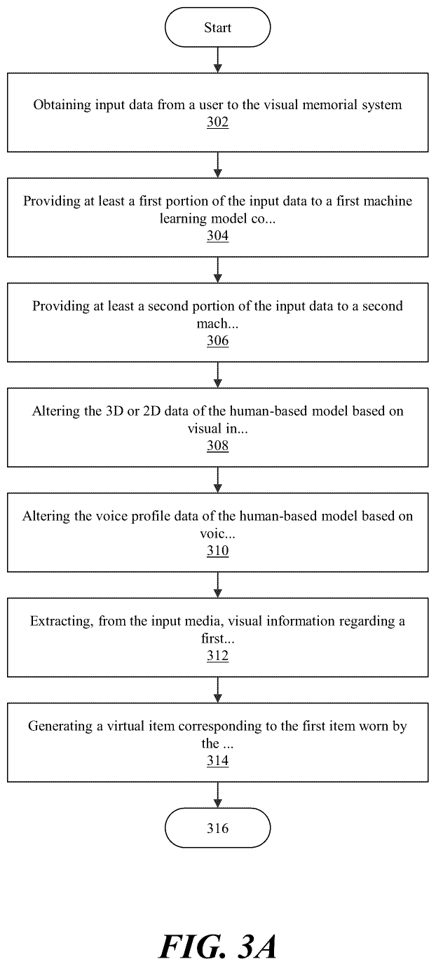

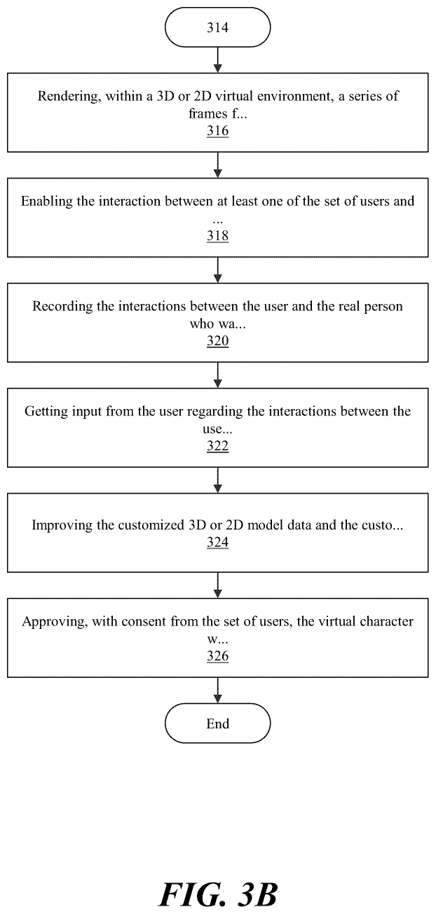

FIGS. 3A to 3B are flowcharts that describe a method, according to some embodiments of the present disclosure. In some embodiments, at 302, the method may include obtaining input data from a user to the visual memorial system. At 304, the method may include providing at least a first portion of the input data to a first machine learning model configured to extract visual information regarding the real person, depicted in at least a video recording of the real person and the set of pictures of the real person.

In some embodiments, at 306, the method may include providing at least a second portion of the input data to a second machine learning model configured to extract voice information regarding the real person depicted in at least the set of audio files containing the voices of the real person. At 308, the method may include altering the 3D or 2D data of the human-based model based on visual information extracted by the first machine learning model to generate customized 3D or 2D model data corresponding to the real person.

In some embodiments, at 310, the method may include altering the voice profile data of the human-based model based on voice information extracted by the second machine learning model to generate customized voice profile data corresponding to the real person. At 312, the method may include extracting, from the input media, visual information regarding a first item worn by the real person as depicted in the input media.

In some embodiments, at 314, the method may include generating a virtual item corresponding to the first item worn by the real person. At 316, the method may include rendering, within a 3D or 2D virtual environment, a series of frames for display that depict a virtual character that resembles the real person performing one or more actions. At 326, the method may include approving, with consent from the set of users, the virtual character with the 3D or 2D data and the voice profile data.

In some embodiments, the visual memorial system may include a memory system that stores three-dimensional (3D) model data or two-dimensional (2D) model data for virtual characters and voice profile model data for visual characters. The 3D or 2D model data may comprise a human-based model. The human-based model comprises 3D or 2D data defining face and body of a generic human figure. The 2D model data may be gathered from 2D image of human photos that may comprise face or the whole body.

In some embodiments, the digital memorial system may be configured to generate a set of sequences of 2D images or videos with same person in the human photos but with many different poses, views, gestures, facial expressions, and lip movements that may be configured to reflect 3D effects. Voice profile model data comprises voice profile data defining voice characters of the generic human figure. A computing system may be coupled to the memory system.

In some embodiments, the computing system may be in electronic communication with the data store and configured to execute computer-readable instructions that configure the computing system to. The input data may depict a real person. The input media comprises at least a video recording of the real person, a set of pictures of the real person, and a set of audio files containing voices of the real person. The real person was a user's relative who passed away.

In some embodiments, the input data may be submitted by the user to the digital memorial system. The first item may comprise a clothing item or an accessory. The virtual item may include a texture generated based on the visual information. At 318, the rendering may include enabling the interaction between at least one of the set of users and the visual character depicting the real person who was the user's relative who passed away. At 320, the rendering may include recording the interactions between the user and the real person who was the user's relative who passed away. At 322, the rendering may include getting input from the user regarding the interactions between the user and the real person who was the user's relative who passed away. At 324, the rendering may include improving the customized 3D or 2D model data and the customized voice profile data based on the input from the user. A visual appearance of the virtual character as rendered may be based at least in part on the customized 3D or 2D model data and includes a depiction of the virtual character wearing the virtual item. The visual character may be configured to speak using customized voice profile data corresponding to the real person.

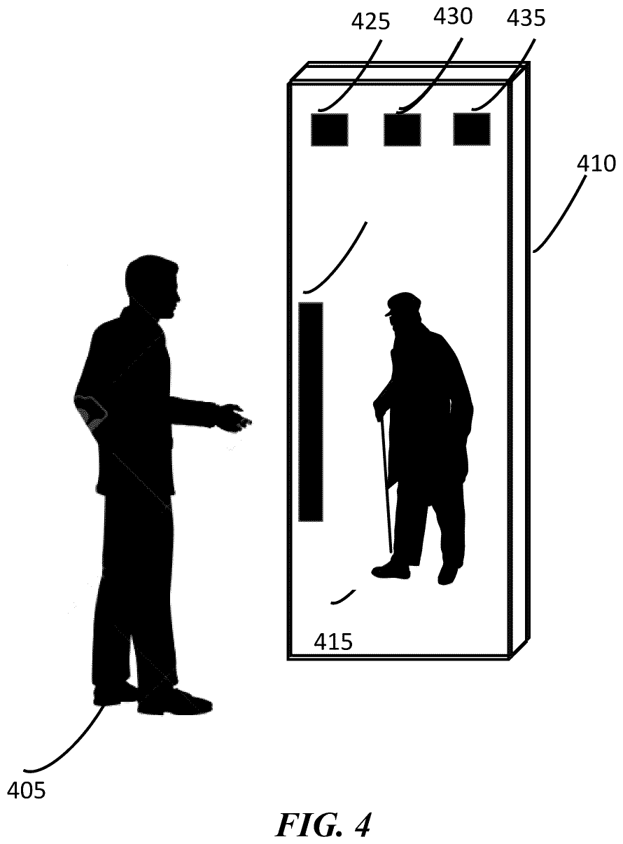

FIG. 4 is an example of providing a digital memorial system with artificial intelligence (AI).

In some embodiments, a user 405 interacts with a smart display 410 in a private setting. In some embodiments, the smart display 410 could be LED or OLED based. In some embodiments, interactive panels 420 is attached to the smart display 410. In some embodiments, an AI-based visual person 415 is configured to act as a human avatar with very similar or same visual appearance, voice profile, behavior pattern, and personality as a passed relative of the user 405, showing on the smart display 410. User 405's goal is to interact with visual person 420 as user 405 would like with the passed relative. In some embodiments, the visual assistant 415 can be activated via certain online secure means by the user 405. In some embodiments, camera 430 and microphone 435 are attached to the smart display. In some embodiments, interactive panel 420, sensor 425, camera 430 and microphone 435 are coupled to a central processor. In some embodiments, interactive panel 420, sensor 425, camera 430 and microphone 435 are coupled to a server via wireless links. In some embodiments, the user 405 can interact with the visual person 415 using methods described in FIG. 1A, FIG. 2A, FIG. 2B, FIG. 3A and FIG. 3B and with the help of interactive panel 420, sensor 425, camera 430 and microphone 435.

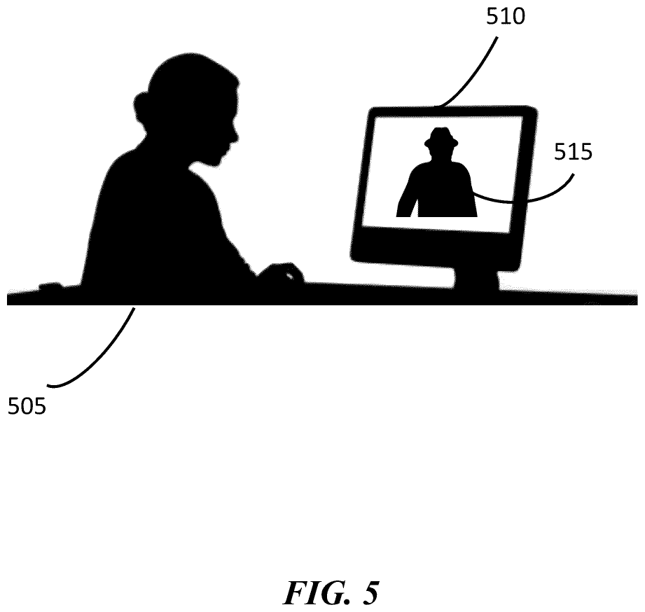

FIG. 5 is another example of providing a digital memorial system with artificial intelligence (AI). In some embodiments, a user 505 interacts with a smart display 510 in a private setting. In some embodiments, the smart display 510 could be LED or OLED based computer system. In some embodiments, interactive tools such as touch screen, keyboards are attached to the smart display 510. In some embodiments, an AI-based visual person 515 is configured to act as a human avatar with very similar or same visual appearance, voice profile, behavior pattern, and personality to a passed relative of the user 505, showing on the smart display 510. User 505's goal is to interact with visual person 515 as user 505 would like with the passed relative. In some embodiments, the visual assistant 515 can be activated by certain online secure means by the user 505. In some embodiments, cameras and microphones are attached to the smart display. In some embodiments, interactive tools, sensors, cameras and microphones are coupled to a central processor. In some embodiments, the user 505 can interact with the visual person 515 using methods descripted in FIG. 1, FIG. 2A, FIG. 2B, FIG. 3A and FIG. 3B.

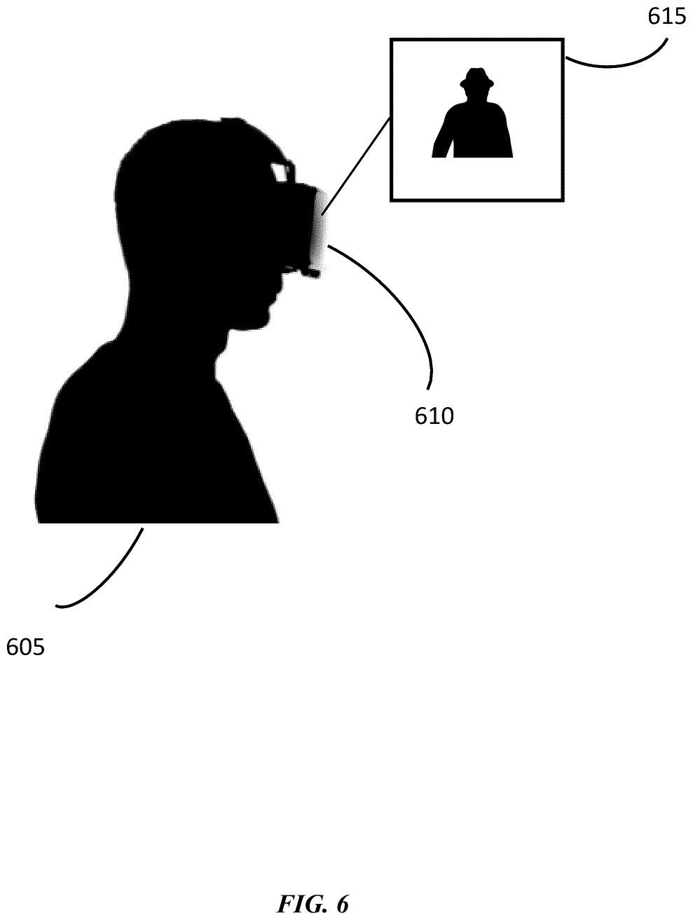

FIG. 6 is a third example of providing a digital memorial system with artificial intelligence (AI).

In some embodiments, a user 605 interacts with a virtual reality (VR) or augmented reality (AR) device 610 in a private setting. In some embodiments, interactive tools are attached to the device 610. In some embodiments, an AI-based visual person 615 is configured to act as a human avatar with very similar or same visual appearance, voice profile, behavior pattern, and personality to a passed relative of the user 605, showing on the device 610. User 605's goal is to interact with visual person 615 as user 605 would like with the passed relative. In some embodiments, cameras and microphones are attached to the device 610. In some embodiments, interactive tools, sensors, cameras and microphones are coupled to a central processor. In some embodiments, the user 605 can interact with the visual person 615 using methods descripted in FIG. 1, FIG. 2A, FIG. 2B, FIG. 3A and FIG. 3B.

1. A digital memorial system comprising:
a memory system that stores three-dimensional (3D) or two-dimensional (2D) model data for virtual characters and voice profile model data for visual characters, wherein the 3D or 2D model data comprises a human-based model, wherein the human-based model comprises 3D or 2D data defining face and body of a generic human figure, wherein voice profile model data comprises voice profile data defining voice characters of the generic human figure, wherein the 2D model data is gathered from 2D image of human photos that may comprise face or the whole body, wherein the digital memorial system is configured to generate a set of sequences of 2D images or videos with same person in the human photos but with many different poses, views, gestures, facial expressions, and lip movements that are configured to reflect 3D effects; and
a computing system in electronic communication with the data store and configured to execute computer-readable instructions that configure the computing system to:
obtain input data depicting a real person, wherein the input data comprises a set of video recordings of the real person, a set of pictures of the real person, a set of audio files containing voices of the real person, a file describing habits, behaviors belong to the real person, wherein the real person was a person who passed away, wherein a first part of the input data was submitted by a set of users of the digital memorial system, wherein the set of users were the real person's relatives, colleagues and friends, wherein a second part of the input data was submitted by the real person before the real person passed away;
provide at least a first portion of the input data to a first machine learning model configured to extract visual information regarding the real person, depicted in the set of video recordings of the real person and the set of pictures of the real person;
provide at least a second portion of the input data to a second machine learning model configured to extract voice information regarding the real person depicted in the at least the set of audio files containing the voices of the real person;
alter the 3D or 2D data of the human-based model based on visual information extracted by the first machine learning model to generate customized 3D or 2D model data corresponding to the real person;
alter the voice profile data of the human-based model based on voice information extracted by the second machine learning model to generate customized voice profile data corresponding to the real person;
extract, from the input media, visual information regarding a first item worn by the real person as depicted in the input media, wherein the first item comprises a clothing item or an accessory;
generate a virtual item corresponding to the first item worn by the real person, wherein the virtual item includes a texture generated based on the visual information;
render, within a 3D or 2D virtual environment, a series of frames for display that depict a virtual character that resembles the real person performing one or more actions, wherein a visual appearance of the virtual character as rendered is based at least in part on the customized 3D or 2D model data and includes a depiction of the virtual character wearing the virtual item, wherein the visual appearance of the visual character is based at least in part on the habits, behaviors belong to the real person, wherein the visual character is configured to speak using customized voice profile data corresponding to the real person;
approve, with the consent from the set of users, the virtual character with the three-dimensional 3D or 2D model data and the voice profile data; and
enable the interaction between at least one of the set of users and the visual character depicting the real person who was the user's relative who passed away.

2. A method to implement a visual memorial system, comprising:
obtaining input data from a user to the visual memorial system, wherein the visual memorial system includes a memory system that stores three-dimensional (3D) or two-dimensional (2D) model data for virtual characters and voice profile model data for visual characters, wherein the 3D or 2D model data comprises a human-based model, wherein the human-based model comprises 3D or 2D data defining face and body of a generic human figure, wherein the 2D model data is gathered from 2D image of human photos that may comprise face or the whole body, wherein the digital memorial system is configured to generate a set of sequences of 2D images or videos with same person in the human photos but with many different poses, views, gestures, facial expressions, and lip movements that are configured to reflect 3D effects, wherein voice profile model data comprises voice profile data defining voice characters of the generic human figure, wherein a computing system is coupled to the memory system, wherein the computing system is in electronic communication with the data store and configured to execute computer-readable instructions that configure the computing system to wherein the input data depicts a real person, wherein the input data comprises a set of video recordings of the real person, a set of pictures of the real person, a file describing habits, behaviors belong to the real person, and a set of audio files containing voices of the real person, wherein the real person was a person who passed away, wherein a first part of the input data was submitted by a set of users of the digital memorial system, wherein the set of users were the real person's relatives, colleagues and friends, wherein a second part of the input data was submitted by the real person before the real person passed away;
providing at least a first portion of the input data to a first machine learning model configured to extract visual information regarding the real person, depicted in the set of video recordings of the real person and the set of pictures of the real person;
providing at least a second portion of the input data to a second machine learning model configured to extract voice information regarding the real person depicted in the at least the set of audio files containing the voices of the real person;
altering the 3D or 2D data of the human-based model based on visual information extracted by the first machine learning model to generate customized 3D or 2D model data corresponding to the real person;
altering the voice profile data of the human-based model based on voice information extracted by the second machine learning model to generate customized voice profile data corresponding to the real person;
extracting, from the input media, visual information regarding a first item worn by the real person as depicted in the input media, wherein the first item comprises a clothing item or an accessory;
generating a virtual item corresponding to the first item worn by the real person, wherein the virtual item includes a texture generated based on the visual information;
rendering, within a 3D or 2D virtual environment, a series of frames for display that depict a virtual character that resembles the real person performing one or more actions, wherein a visual appearance of the virtual character as rendered is based at least in part on the customized 3D or 2D model data and includes a depiction of the virtual character wearing the virtual item, wherein the visual appearance of the visual character is based at least in part on the habits, behaviors belong to the real person, wherein the visual character is configured to speak using customized voice profile data corresponding to the real person;
approving, with the consent from the set of users, the virtual character with the 3D or 2D model data and the voice profile data;
enabling the interaction between at least one of the set of users and the visual character depicting the real person who was the user's relative who passed away.

3. A method to implement a visual memorial system, comprising:
obtaining input data from a user to the visual memorial system, wherein the visual memorial system includes a memory system that stores three-dimensional (3D) model data or two-dimensional (2D) model data for virtual characters and voice profile model data for visual characters, wherein the 3D or 2D model data comprises a human-based model, wherein the human-based model comprises 3D or 2D data defining face and body of a generic human figure, wherein the 2D model data is gathered from 2D image of human photos that may comprise face or the whole body, wherein the digital memorial system is configured to generate a set of sequences of 2D images or videos with same person in the human photos but with many different poses, views, gestures, facial expressions, and lip movements that are configured to reflect 3D effects, wherein voice profile model data comprises voice profile data defining voice characters of the generic human figure, wherein a computing system is coupled to the memory system, wherein the computing system is in electronic communication with the data store and configured to execute computer-readable instructions that configure the computing system to wherein the input data depicts a real person, wherein the input media comprises at least a video recording of the real person, a set of pictures of the real person, and a set of audio files containing voices of the real person, wherein the real person was a user's relative who passed away, wherein the input data is submitted by the user to the digital memorial system;
providing at least a first portion of the input data to a first machine learning model configured to extract visual information regarding the real person, depicted in the at least a video recording of the real person and the set of pictures of the real person;
providing at least a second portion of the input data to a second machine learning model configured to extract voice information regarding the real person depicted in the at least the set of audio files containing the voices of the real person;
altering the 3D or 2D data of the human-based model based on visual information extracted by the first machine learning model to generate customized 3D or 2D model data corresponding to the real person;
altering the voice profile data of the human-based model based on voice information extracted by the second machine learning model to generate customized voice profile data corresponding to the real person;
extracting, from the input media, visual information regarding a first item worn by the real person as depicted in the input media, wherein the first item comprises a clothing item or an accessory;
generating a virtual item corresponding to the first item worn by the real person, wherein the virtual item includes a texture generated based on the visual information;
rendering, within a 3D or 2D virtual environment, a series of frames for display that depict a virtual character that resembles the real person performing one or more actions, wherein a visual appearance of the virtual character as rendered is based at least in part on the customized 3D or 2D model data and includes a depiction of the virtual character wearing the virtual item, wherein the visual character is configured to speak using customized voice profile data corresponding to the real person;
enabling the interaction between at least one of the set of users and the visual character depicting the real person who was the user's relative who passed away;
recording the interactions between the user and the real person who was the user's relative who passed away;
getting input from the user regarding to the interactions between the user and the real person who was the user's relative who passed away;
improving the customized 3D or 2D model data and the customized voice profile data based on the input from the user; and
approving, with the consent from the set of users, the virtual character with the 3D or 2D data and the voice profile data.
